(19) United States
(12) Patent Application Publication
(10) Pub. No.: US 2003/0211796 A1
(43) Pub. Date: Nov. 13, 2003

(54) Flame-inhibiting finishing of articles containing organic latent-heat storage materials

(75) Inventors: Ekkehard Jahns, Weinheim (DE); Marco Schmidt, Speyer (DE); Joachim Pakusch, Speyer (DE); Horst Seibert, Fussgoenheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Akitengesellshaft, Ludwigshafen (DE)

(21) Appl. No.: 10/419,951

(22) Filed: Apr. 22, 2003

(30) Foreign Application Priority Data
May 13, 2002 (DE) 102 21 222.8

(51) Int. Cl. B32B 27/02; B32B 23/02; B32B 15/02

(52) U.S. Cl. 442/136; 428/402.2

(57) ABSTRACT

Use of intumescent coating materials for the flame-inhibiting finishing of articles containing microencapsulated organic latent-heat storage materials.

The present invention relates to the use of intumescent coating materials for the flame-inhibiting finishing of articles containing microencapsulated organic latent-heat storage materials, and to articles provided with a flame-inhibiting finish which contain microencapsulated organic latent-heat storage materials.

An important research aim for reducing the demand for energy and utilizing available thermal energy are latent-heat storage systems. They are widely used, for example as heat stores in insulating materials or building materials and in textiles. Their mode of functioning is based on the enthalpy of conversion which occurs at the solid/liquid phase transition and which results in energy take-up or energy release from or to the environment. They can thus be used firstly for temperature regulation in a defined temperature range and secondly, in a suitable arrangement, effect an improvement in thermal insulation.

However, latent-heat storage materials are frequently readily combustible paraffins. This combustibility is unacceptable, depending on the area of application, but generally results in increased combustibility of the articles containing latent-heat storage materials. Examples which may be mentioned are building materials, since high requirements regarding flame protection generally exist in building construction.

There have been a very wide variety of attempts to make the microcapsules more flame-resistant. U.S. Pat. No. 5,435,376 describes microencapsulated latent-heat storage materials which are not combustible. However, non-combustible latent-heat storage materials of this type generally store an insufficient amount of heat. The specification furthermore discloses mixtures of latent-heat storage materials and flame inhibitors as capsule core for textiles, shoes, boots and building insulation. This admixture of flame retardants only results in a slight improvement in the combustion values, or none at all.

U.S. Pat. No. 6,099,894, U.S. Pat. Nos. 6,171,647 and 6,270,836 describe a metal-oxide gel coating of microcapsules which results in improved flame protection of the capsules.

Improved flame protection of the actual microcapsules is of little use in cases in which the capsules have been processed together with other materials. It has been observed that when articles containing microcapsules burn, flame retardants as admixture to the latent-heat storage materials or protective capsule coatings have virtually no effect.

Intumescent coating materials are known as flame-inhibiting finishes for steel constructions, ceilings, walls, wood and cables.

Their mode of action is based on the formation of an expanded, insulating layer of low-flammability material which forms under the action of heat and which protects the substrate against ingress of oxygen and/or overheating and thus prevents or delays the burning of combustible substrates.

Conventional systems consist of a film-forming binder, a char former, a blowing agent and an acid former as essential components.

Intumescent coating materials having a special composition are described, for example, in DE-A-199 09 387 and WO 99/27021.

The present invention now had the object of providing improved fire protection for articles containing microencapsulated organic latent-heat storage materials.

We have found that this object is achieved by the use of intumescent coating materials for the flame-inhibiting finishing of articles containing microencapsulated organic latent-heat storage materials.

Intumescent coating materials comprise various active constituents which, in the case of a temperature increase in the case of a fire, liberate gas and carbonize. The liberated gas results in expansion of the coating, to up to 80 times its original volume. The carbon-containing structure is a heat barrier and only burns itself at temperatures above 700° C. Numerous intumescent formulations are disclosed in “Fire-Retardant Formulations Handbook” (author: Vijay Mohan Bhatnagar, 1972).

Intumescent coating materials generally comprise char formers, acid formers, blowing agents, film-forming binders and, if desired, conventional auxiliaries and additives.

The mechanism of action of intumescent systems under the action of heat can be described in a simplified manner as follows:

1. At a temperature above 70° C., the binder system softens to form a highly viscous melt.

2. Above about 90° C., decomposition of blowing agent and plasticizer commences, with liberation of non-combustible gases, which form an inert gas layer above the coating and prevent the combustible organic constituents of the coating from burning.

3. The acid former liberates ammonia above about 150° C., leaving free acid, which lowers the viscosity of the melt.

4. The char former melts and reacts with the acid liberated under 3, with elimination of water and carbonization.

5. The blowing agent decomposes with formation of inert gases and expands the melt to give a soft foam.

At temperatures of about 210° C., reactions 3, 4. and 5. proceed simultaneously.

6. Through partial decomposition, the soft foam is converted into a relatively rigid layer.

7. The acid still present reacts with pigment material (metal oxides) present with formation of phosphates.

8. The carbon-containing protective layer is partially removed by the flame, reducing the insulating action. Phosphorus can likewise escape from the system if no metal oxides are available for an initial reaction (7.).

9. Depending on the composition of the residue, phase transitions or melting can occur.

Char formers are compounds which decompose to form carbon (carbonization) together with the acid liberated by the acid former. Such compounds are, for example, carbohydrates, such as mono-, di- and tri-pentaerythritol, polycondensates of pentaerythritol, sugars, starch and starch derivatives.

Acid formers are compounds having a high phosphorus content which liberate phosphoric acid at elevated temperature. Such compounds are, for example, ammonium polyphosphates, urea phosphate and diammonium phosphate. Preference is given to polyphosphates since they have a greater content of active phosphorus.

Blowing agents, the foam-forming substances, liberate non-combustible gas on decomposition. Blowing agents are, for example, chlorinated paraffins or nitrogen-containing compounds, such as urea, dicyanamide, guanidine or crystalline melamine. It is advantageous to use blowing agents having different decomposition temperatures in order in this way to extend the duration of gas liberation and thus to increase the foam height.

Also suitable are components whose mode of action is not restricted to a single function, such as melamine polyphosphate, which acts both as acid former and as blowing agent. Further examples are described in GB-A-2,007,689, EP-A-139 401 and U.S. Pat. No. 3,969,291.

The film-forming binders comprise the abovementioned components. Under the action of heat, they melt, enabling the intumescence reaction to take place in the liquid phase. Film-forming binders are, for example, homopolymers based on vinyl acetate, copolymers based on vinyl acetate, ethylene and vinyl chloride, copolymers based on vinyl acetate and the vinyl ester of a long-chain, branched carboxylic acid, copolymers based on vinyl acetate and di-n-butyl maleate, copolymers based on vinyl acetate and acrylates, copolymers based on styrene and acrylates and/or copolymers based on acrylates, vinyltolueneacrylate copolymer, styreneacrylate copolymer, vinylacrylate copolymer and self-crosslinking polyurethane dispersions.

Conventional auxiliaries and additives are, for example, additives which improve the properties of the foam. Examples of such additives are zinc borate, aluminum trihydrate and antimony oxide. In addition, the coating materials may be pigmented with titanium dioxide, molybdenum oxide and/or zirconium oxide, which additionally have a thermally insulating action. For improved application, the coating materials may also comprise suitable plasticizers or thixotropy agents. Auxiliaries may furthermore be fillers, such as glass fibers, mineral fibers, kaolin, talc, aluminum oxide, aluminum hydroxide, magnesium hydroxide, precipitated silicic acids, silicates and/or powdered celluloses.

Intumescent coating materials having a wide variety of compositions are commercially available and are suitable for the use according to the invention. Examples which may be mentioned are the products from Permatex Protective Coatings, Vaihingen/Enz.

The coating material can be applied in any conventional manner, for example by spraying, dipping, drawing or brushing. They are preferably employed in the form of a brushable, sprayable or rollable paint. In general, a film with a thickness of 0.1-3 mm is applied (dry-layer thickness).

Depending on the film-forming binder, a distinction can be made between various classes of intumescent coating materials:

chlorinated rubber coating materials based on chlorinated rubber as binder, glass fibers and melamine phosphate as acid-liberating catalyst and blowing agent;

water-based latex coating materials comprising polyvinyl acetate latex together with pentaerythritol, dicyandiamide, carboxymethylcellulose, titanium dioxide, melamine phosphate and/or ammonium polyphosphate. Some formulations comprise ethylenevinyl acetate or acrylonitrilevinyl acetate latex in addition to melamine polyphosphate and/or ammonium polyphosphate;

vinyl coating materials generally comprise a combination of copolymer or terpolymer of vinyl chloride or vinylidene chloride and melamine phosphate. It is advantageous to add p,p′-oxybisbenzenesulfonamide and/or melamine polyphosphate, which improve the coal and reduce flame propagation;

epoxy coating materials comprise diglycidylbisphenol A epoxide, melamine pyrophosphate, dicyandiamide, urea and borax. A typical formulation comprises chloroalkyl phosphate ester, ammonium polyphosphate and/or melamine pyrophosphate, melamine, a pentaerythritol, toner thickener, zinc borate and other zinc compounds, mineral fibers and an epoxy resin;

amino resin coating materials comprise melamine-formaldehyde or urea-formaldehyde resin, sodium carbonate, alkali metal silicate, melamine phosphate and polyphosphate.

The intumescent coating materials are used in accordance with the invention for the flame-inhibiting finishing of articles containing microencapsulated organic latent-heat storage materials.

These articles may be moldings which contain the microencapsulated organic latent-heat storage materials as such, and conventional moldings which have a coating comprising the microcapsules, or textiles and nonwovens.

The intumescent coating materials are preferably used for the finishing of articles made from binding building materials. Binding building materials comprise mineral, silicate or polymeric binders. In addition to the binder, moldings with mineral binders comprise water, aggregates such as grit, sand, glass or mineral fibers, and, if desired, auxiliaries. Mineral binders are generally known. They are finely divided inorganic substances, such as lime, gypsum, alumina, clay and cement, which are converted into their ready-to-use form by stirring with water and which solidify when drying as a function of time, if desired at elevated temperature. The dry compositions of mineral binding building materials typically contain from 5 to 50% by weight of microencapsulated latent-heat storage materials, based on the amount of mineral binders.

The intumescent coating materials are preferably employed in articles containing gypsum as binding building material.

The gypsum is preferably in the form of gypsum-containing moldings, such as gypsum plasterboards or conventional articles, such as walls or ceilings which have gypsum plaster as coating. They are preferably gypsum plasterboards. Gypsum plasterboards containing microencapsulated latent-heat storage materials are described in the earlier German patent application 101 39 171.4, which is expressly incorporated herein by way of reference.

Gypsum plasterboards can comprise from 5 to 40% by weight, in particular from 20 to 35% by weight, of incorporated microcapsules, based on the total weight of the gypsum plasterboard (dry weight). The production of gypsum plasterboards is generally known.

Gypsum plasterboards generally consist of a gypsum core with cardboard leaves applied to-both sides. They are usually produced by introducing aqueous gypsum suspension discontinuously or continuously between two cardboard leaves based on cellulose, with boards being shaped. The gypsum suspension is, as generally known, prepared by continuous addition and constant mixing of β-hemihydrate calcium sulfate in water with additives. The microcapsules can either be metered in together with the calcium sulfate or may already be in the form of an aqueous dispersion.

The gypsum suspension obtained in this way is applied to the cardboard leaves and covered with cardboard.

As curing commences, the boards are shaped in a press to give strips having a width of, for example, 1.2-1.25 m and a thickness of 9.25, 12.5, 15.0, 18.0 or 25 mm. These strips cure completely within a few minutes and are cut to give boards. At this stage, the boards generally still comprise a third of their weight in the form of free water. In order to remove the residual water, the boards are subjected to heat treatment at temperatures of about 250° C. The gypsum plasterboards obtained in this way have a density of 750-950 kg/M³.

For gypsum plasterboards, cardboard having a weight of about 300 g/m² is usually employed.

Instead of cardboard based on cellulose, alternative, fiber-like structures can also be used to cover the gypsum plasterboards according to the invention on both sides. Alternative materials are polymer fibers made, for example, of polypropylene, polyester, polyamide, polyacrylates, polyacrylonitrile and the like. Glass fibers are also suitable. The alternative materials can be employed in the form of woven fabric and as so-called nonwovens.

Gypsum plasterboards of this type are disclosed, for example, in U.S. Pat. No. 4,810,569, U.S. Pat. No. 4,195,110 and U.S. Pat. No. 4,394,411.

Increased adhesion of the gypsum to substrates such as cardboard can be achieved, as is known to the person skilled in the art, by addition of natural and/or synthetic polymers.

The intumescent coating materials can furthermore preferably be employed for the finishing of coating materials for conventional moldings. In addition to the microencapsulated latent-heat storage materials, these coating compositions can contain the abovementioned binding building materials, such as mineral, silicate or polymeric binders, and, if desired, fillers.

The intumescent coating materials can furthermore be employed for finishing polymeric moldings or conventional moldings with polymeric coating compositions which contain microencapsulated latent-heat storage materials.

These are taken to mean thermoplastic and thermosetting plastics during the processing of which the microcapsules are not destroyed. Examples are epoxy, urea, melamine, polyurethane and silicone resins. The moldings may also consist of plastic foams and fibers. Examples of foams are polyurethane foam, polystyrene foam, latex foam and melamine resin foam.

The mineral moldings can also have been foamed correspondingly.

The intumescent coating materials can furthermore be used for finishing textiles or nonwovens containing microencapsulated latent-heat storage materials. In textiles or nonwovens, the microcapsules may be present directly in the fibers in the case of synthetic fibers. In general, however, they are applied to the woven or nonwoven by generally known methods, such as printing, knife coating, brushing or coating with a microcapsule dispersion containing a latent-heat storage medium, and dried. Textiles or nonwovens of this type are subsequently treated with the intumescent coating material.

Microencapsulated latent-heat storage materials are particles having a capsule core consisting predominantly, to the extent of more than 95% by weight, of organic latent-heat storage materials and a polymer as capsule wall. The capsule core here is solid or liquid, depending on the temperature. The mean particle size of the capsules is from 0.5 to 100 μm, preferably from 1 to 80 μm, in particular from 1 to 50 μm.

Latent-heat storage materials are organic lipophilic substances which have their solid/liquid phase transition at a temperature in the range from −20 to 120° C.

Examples of suitable substances which may be mentioned are the following:

aliphatic hydrocarbon compounds, such as saturated or unsaturated C₁₀-C₄₀-hydrocarbons, which may be branched or preferably linear, for example n-tetradecane, n-pentadecane, n-hexadecane, n-heptadecane, n-octadecane, n-nonadecane, n-eicosane, n-heneicosane, n-docosane, n-tricosane, n-tetracosane, n-pentacosane, n-hexacosane, n-heptacosane, n-octacosane, and cyclic hydrocarbons, for example cyclohexane, cyclooctane, cyclodecane;

aromatic hydrocarbon compounds, such as benzene, naphthalene, biphenyl, o- or n-terphenyl, C₁-C₄₀-alkyl-substituted aromatic hydrocarbons, such as dodecylbenzene, tetradecylbenzene, hexadecylbenzene, hexylnaphthalene or decylnaphthalene;

saturated or unsaturated C₆-C₃₀-fatty acids, such as lauric acid, stearic acid, oleic acid or behenic acid, preferably eutectic mixtures of decanoic acid with, for example, myristic acid, palmitic acid or lauric acid;

fatty alcohols, such as lauryl alcohol, stearyl alcohol, oleyl alcohol, myristyl alcohol or cetyl alcohol, or mixtures of coconut fatty alcohol, and the so-called oxo alcohols, which are obtained by hydroformylation of α-olefins and further reactions;

C₆-C₃₀-fatty amines, such as decylamine, dodecylamine, tetradecylamine or hexadecylamine;

esters, such as C₁-C₁₀-alkyl esters of fatty acids, such as propyl palmitate, methyl stearate or methyl palmitate, and preferably their eutectic mixtures or methyl cinnamate;

natural and synthetic waxes, such as montanic acid wax, montanic ester wax, carnauba wax, polyethylene wax, oxidated waxes, polyvinyl ether wax, ethylenevinyl acetate wax or hard waxes by the Fischer-Tropsch process.

Also suitable are mixtures of these substances so long as a melting-point reduction outside the desired range does not occur or the heat of melting of the mixture is too low for reasonable use.

It is furthermore advantageous to add soluble compounds to the capsule core-forming substances therein in order in this way to prevent the freezing-point depression which occurs in some cases in non-polar substances. It is advantageous, as described in U.S. Pat. No. 5,456,852, to use compounds having a melting point which is from 20 to 120° C. higher than that of the actual core substance. Suitable compounds are the fatty acids, fatty alcohols, fatty amides and aliphatic hydrocarbon compounds mentioned above as lipophilic substances.

The lipophilic substances are selected depending on the temperature range in which the heat-storage property is desired. For example, lipophilic substances whose solid/liquid phase transition is at a temperature in the range from 0 to 60° C. are preferably used for heat-storage materials in building materials in Europe. Thus, individual substances or mixtures having transition temperatures of from 0 to 25° C. are generally selected for outdoor applications and from 15 to 30° C. for indoor applications. In the case of solar applications in combination with building materials as storage medium or to prevent overheating of transparent thermal insulation, as described in EP-A 333 145, transition temperatures of from 30 to 60° C. are particularly suitable. For example, it is advantageous to use alkane mixtures, as they arise as industrial distillate and are commercially available as such. Preference is given to latent-heat storage materials which essentially consist of n-alkanes.

Polymers which can be used for the capsule wall are in principle the materials known for the microcapsules of carbon papers. Thus it is possible, for example, to encapsulate the latent-heat storage materials in gelatine with other polymers by the processes described in GB-A 870 476, U.S. Pat. No. 2,800,457, and U.S. Pat. No. 3,041,289.

Preferred wall materials, since they are very aging-stable, are thermosetting polymers. The term thermosetting here is taken to mean wall materials which, owing to the high degree of crosslinking, do not soften, but instead decompose at high temperatures. Suitable thermosetting wall materials are, for example, formaldehyde resins, polyureas and polyurethanes as well as highly crosslinked methacrylate polymers.

The term formaldehyde resins is taken to mean products of the reaction of formaldehyde with

triazines, such as melamine

carbamides, such as urea

phenols, such as phenol, m-cresol and resorcinol,

amino and amido compounds, such as aniline, p-toluenesulfonamide, ethyleneurea and guanidine,

or mixtures thereof.

Preferred formaldehyde resins are urea-formaldehyde resins, urea-resorcinol-formaldehyde resins, urea-melamine resins and melamine-formaldehyde resins. Preference is likewise given to the C₁-C₄-alkyl, in particular methyl ethers of these formaldehyde resins and to mixtures with these formaldehyde resins. Particular preference is given to melamine-formaldehyde resins and/or methyl ethers thereof.

In the processes known from carbon papers, the resins are employed in the form of prepolymers. The prepolymer is still soluble in the aqueous phase and migrates to the surface during the polycondensation and surrounds the oil droplets. Processes for microencapsulation with formaldehyde resins are generally known and are described, for example, in EP-A-562 344 and EP-A-974 394.

Capsule walls made from polyureas and polyurethanes are likewise known from carbon papers. The capsule walls are formed by reaction of reactants carrying NH₂ groups or OH groups with di- and/or polyisocyanates. Suitable isocyanates are, for example, ethylene diisocyanate, 1,4-tetramethylene diisocyanate, 1,6-hexamethylene diisocyanate and 2,4- and 2,6-tolylene diisocyanate. Mention may furthermore be made of polyisocyanates, such as derivatives having a biuret structure, polyuretoneimines and isocyanurates. Suitable reactants are hydrazine, guanidine and salts thereof, hydroxylamine, di- and polyamines and aminoalcohols. Interfacial polyaddition process of this type are disclosed, for example, in U.S. Pat. No. 4,021,595, EP-A 0,392,876 and EP-A 0,535,384.

The capsule walls are preferably polymers based on one or more C₁-C₂₄-alkyl esters of acrylic and/or methacrylic acid.

Preference is given to microcapsules whose capsule wall is a highly crosslinked methacrylate polymer. The degree of crosslinking here is achieved with a crosslinker proportion of ≧10% by weight, based on the polymer as a whole.

The preferred microcapsules are built up from 30 to 100% by weight, preferably from 30 to 95% by weight, of one or more C₁-C₂₄-alkyl esters of acrylic and/or methacrylic acid as monomer I. In addition, the microcapsules can be built up from up to 80% by weight, preferably from 5 to 60% by weight, in particular from 10 to 50% by weight, of a bi- or polyfunctional monomer as monomers II, which are insoluble or sparingly soluble in water, and from up to 40% by weight, preferably up to 30% by weight, of other monomers III.

Suitable monomers I are C₁-C₂₄-alkyl esters of acrylic and/or methacrylic acid. Particularly preferred monomers I are methyl, ethyl, n-propyl and n-butyl acrylate and/or the corresponding methacrylates. Preference is given to isopropyl, isobutyl, sec-butyl and tert-butyl acrylate and the corresponding methacrylates. Methacrylonitrile should furthermore be mentioned. In general, the methacrylates are preferred.

Suitable monomers II are bi- or polyfunctional monomers which are insoluble or sparingly soluble in water, but have good to limited solubility in the lipophilic substance. The term sparing solubility is taken to mean solubility of less than 60 g/l at 20° C.

The term bi- or polyfunctional monomers is taken to mean compounds which have at least 2 non-conjugated ethylenic double bonds.

Principally suitable are divinyl and polyvinyl monomers which effect crosslinking of the capsule wall during polymerization.

Preferred bifunctional monomers are the diesters of diols with acrylic acid or methacrylic acid, furthermore the diallyl and divinyl ethers of these diols.

Preferred divinyl monomers are ethanediol diacrylate, divinylbenzene, ethylene glycol dimethacrylate, 1,3-butylene glycol dimethacrylate, methallylmethacrylamide and allyl methacrylate. Particular preference is given to propanediol diacrylate, butanediol diacrylate, pentanediol diacrylate and hexanediol diacrylate or the corresponding methacrylates.

Preferred polyvinyl monomers are trimethylolpropane triacrylate and methacrylate, pentaerythritol triallyl ether and pentaerythritol tetraacrylate.

Suitable monomers III are other monomers, preferably monomers IIIa, such as styrene, α-methylstyrene, β-methylstyrene, butadiene, isoprene, vinyl acetate, vinyl propionate and vinylpyridine.

Particular preference is given to the water-soluble monomers IIIb, for example acrylonitrile, methacrylamide, acrylic acid, methacrylic acid, itaconic acid, maleic acid, maleic anhydride, N-vinylpyrrolidone, 2-hydroxyethyl acrylate and methacrylate and acrylamido-2-methylpropanesulfonic acid. In addition, mention may be made, in particular, of N-methylolmethacrylamide, dimethylaminoethyl methacrylate and diethylaminoethyl methacrylate.

The microcapsules which are suitable for use in accordance with the invention can be produced by so-called in-situ polymerization.

The preferred microcapsules and their production are disclosed in EP-A-457 154, which is expressly incorporated herein by way of reference. Thus, the microcapsules are produced by preparing a stable oil-in-water emulsion from the monomers, a free-radical initiator, a protective colloid and the lipophilic substance to be encapsulated. The microcapsules are present in this emulsion as the disperse phase. The proportion of the oil phase in the oil-in-water emulsion is preferably from 20 to 60% by weight.

The polymerization of the monomers is subsequently initiated by warming, with the resultant polymers forming the capsule wall, which surrounds the lipophilic substance.

The protective colloids are also disclosed in EP-A-457 154. The inorganic solid particles acting as protective colloids, so-called Pickering systems, which are likewise described in EP-A-457 154 and the earlier German application 101 63 162.6, which are expressly incorporated herein by way of reference, are furthermore suitable. Capsules having a capsule size of from 0.5 to 100 μm, preferably from 1 to 50 μm, depending on the size selected in the emulsification step, are obtained. The capsules have a narrow size distribution.

The microencapsulated latent-heat storage materials obtained in this way can be processed for the articles directly as a dispersion or, after spray-drying, as a capsule powder.

The articles provided in accordance with the invention with the intumescent coating materials are distinguished by poor flammability.

The following examples are intended to explain the use according to the invention:

### EXAMPLE 1

a) A simple intumescent coating material was prepared from the following constituents:

| | |
|---|---|
| 20 g | of water |
| 30 g | of Exolit ® AP (ammonium polyphosphate from Clariant) as |
| | acid former |
| 10 g | of crystalline melamine as blowing agent |
| 10 g | of pentaerythritol as char former |
| 20 g | of Acronal ® 290D (50% by weight styrene-acrylate polymer |
| | dispersion, BASF) as film-forming binder. |

b) Preparation of the microencapsulated latent-heat storage materials:

| | |
|---|---|
| 572 g | of water |
| 80 g | of a 50% by weight colloidal dispersion of SiO₂ in water |
| | at pH 9.3 (number-average particle size 108.6 nm, |
| | according to light scattering) |
| 2.1 g | of a 2.5% by weight aqueous sodium nitrite solution |
| 20 g | of methylcellulose, 1% by weight aqueous solution |
| | (viscosity 15,000 mPas at 2% in water) |

Water Phase:

| | |
|---|---|
| 440 g | of C₁₈-C₂₀-alkane (technical-grade distillate) |
| 77 g | of methyl methacrylate |
| 33 g | of butanediol diacrylate |
| 0.76 g | of ethylhexyl thioglycolate |
| 1.35 g | of t-butyl perpivalate |

Feed 1: 1.09 g of t-butyl hydroperoxide, 70% in water

Feed 2: 0.34 g of ascorbic acid, 0.024 g of NaOH, 56 g of H₂O

The above water phase was initially introduced at room temperature and adjusted to pH 4 using 3 g of 10% nitric acid. After the oil phase had been added, the mixture was dispersed using a high-speed dissolver stirrer at 4 200 rpm. After dispersion for 40 minutes, a stable emulsion having a particle size with a diameter of from 2 to 12 μm was obtained. The emulsion was heated to 56° C. over the course of 4 minutes while stirring using an anchor stirrer. The mixture was heated to 58° C. over the course of a further 20 minutes, to 71° C. over the course of a further 60 minutes and to 85° C. over the course of a further 60 minutes. The microcapsule dispersion formed was cooled to 70° C. with stirring, and feed 1 was added. Feed 2 was metered in over the course of 80 minutes with stirring at 70° C. The mixture was subsequently cooled. The microcapsule dispersion formed had a solids content of 46.8% and a mean particle size D (4.3)=9.5 μm (measured by Fraunhofer diffraction, volume mean). The dispersion was dried in a laboratory spray dryer with two-component nozzle and cyclone separation and a hot-gas inlet temperature of 130° C. and an exit temperature of the powder from the spray tower of 70° C.

c) A plasterboard was produced from 70 parts by weight of plaster of Paris, 30 parts by weight of the microencapsulated latent-heat storage material prepared under b) and 60 parts by weight of water, and dried in air for 14 days.

A plasterboard of this type having the dimensions 10×20×1.2 cm was coated on all sides with the intumescent coating material prepared under a) in a wet-film thickness of about 200 μm. The coating was dried in air for 2 days.

The coated plasterboard was held in a Bunsen burner flame for five minutes and assessed. A carbon foam, which reduced further heating of the plasterboard, formed from the intumescent coating in the region of the flame. Although the board smoked in the fire and the carbon foam glowed, it did not burn visibly. Flame propagation upward did not occur. After the burner flame was extinguished, the board also extinguished after a few seconds.

### Comparative Example

A plasterboard (10×20×1.2 cm) with microencapsulated latent-heat storage materials in accordance with Example 1, but without an intumescent coating material, was likewise held in a Bunsen burner flame for 5 minutes and assessed. The board exhibited significant fire propagation upward, with essentially the gas liberated from the board burning before the board. The board did not break up. After the burner flame was extinguished, the board continued to burn, and the flame did not extinguish of its own accord.

### EXAMPLE 2

A plasterboard (10×20×1.2 cm) with microencapsulated latent-heat storage materials according to claim 1 was coated on all sides with a commercial fire-protection dispersion for wood (Unitherm® 87537, Permatex GmbH, Vaihingen/Enz) in a wet-film thickness of about 200 μm. The coating was dried in air for 2 days.

The coated plasterboard was held in a Bunsen burner flame for five minutes and assessed. A carbon foam with a thickness of about 4 mm, which reduced further heating of the plasterboard, formed from the intumescent coating in the region of the flame. Although the board smoked in the fire and the carbon foam glowed, it did not burn visibly. Fire propagation upward did not occur. After the burner flame was extinguished, the board also extinguished after a few seconds.

We claim:

1. Method of use of intumescent coating materials for the flame-inhibiting finishing of articles which contain microencapsulated organic latent-heat storage materials.

2. Method of use as claimed in claim 1, wherein the coating material comprises char formers, acid formers, blowing agents and film-forming binders.

3. Method of use as claimed in claim 1 for the finishing of articles made from binding building materials.

4. Method of use as claimed in claim 1 for the finishing of articles comprising gypsum.

5. Method of use as claimed in claim 1 for the finishing of textiles or nonwovens.

6. Method of use as claimed in claim 1, wherein the latent-heat storage materials essentially consist of n-alkanes.

7. Method of use as claimed in claim 1, wherein the microencapsulated latent-heat storage materials have capsule walls comprising polymers based on one or more C₁-C₂₄-alkyl esters of acrylic and/or methacrylic acid.

8. An article provided with a flame-inhibiting finish of an intumescent coating material and containing microencapsulated organic latent-heat storage materials as claimed in claim 1.
